(19) United States
(12) Patent Application Publication
(10) Pub. No.: US 2009/0246682 A1
(43) Pub. Date: Oct. 1, 2009

(54) METHOD FOR PRODUCING DEVELOPING AGENT

(75) Inventors: Takafumi Hara, Mishima-shi (JP); Takashi Urabe, Sunto-gun (JP); Takayasu Aoki, Mishima-shi (JP); Tsuyoshi Itou, Izunokuni-shi (JP); Yasuhito Noda, Mishima-shi (JP); Motonari Udo, Mishima-shi (JP); Satoshi Araki, Izunokuni-shi (JP); Masahiro Ikuta, Mishima-shi (JP); Asumi Matsumoto, Sunto-gun (JP); Yasuo Goto, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/412,913

(22) Filed: Mar. 27, 2009

Related U.S. Application Data
(60) Provisional application No. 61/040,888, filed on Mar. 31, 2008.
(60) Provisional application No. 61/097,650, filed on Sep. 17, 2008.
(60) Provisional application No. 61/097,651, filed on Sep. 17, 2008.

(51) Int. Cl. G03G 5/00

(52) U.S. Cl. 430/137.19

(57) ABSTRACT

A surfactant is added in an amount of from 0.1 to 5% by weight of the total weight of a developing agent at the time of at least either kneading a toner material or subjecting the toner material to mechanical shearing.

### CROSS-REFERENCE TO RELATED APPLICATION

This application is based upon and claims the benefit of priority from U.S. Provisional Applications No. 61/040,888, filed on Mar. 31, 2008, No. 61/097,650, filed on Sep. 17, 2008, and No. 61/097,651, filed on Sep. 17, 2008, the entire contents of which are incorporated herein by reference.

### TECHNICAL FIELD

The present invention relates to a method for producing a developing agent for developing an electrostatic image or a magnetic latent image in electrophotography, electrostatic printing, magnetic recording, and the like.

### BACKGROUND

In electrophotography, an electric latent image is formed on an electrostatic latent image carrying member (such as a photoreceptor), subsequently the latent image is developed with a toner, and a toner image is transferred to a transfer material such as paper and fixed thereon by heating, pressurizing or the like. A full color image can be formed using toners of various colors as well as a black toner.

As the toner, a two-component developing agent to be used by mixing with carrier particles and a one-component developing agent to be used as magnetic toner particles or non-magnetic toner particles are known. These toners are commonly produced by a kneading pulverization method. This kneading pulverization method is a method for producing desired toner particles by melt-kneading a binder resin, a coloring agent, a release agent such as a wax, a charge controlling agent and the like, cooling the resulting kneaded material, followed by finely pulverizing the cooled material, and then classifying the finely pulverized material. Inorganic and/or organic fine particles can be added to the surface of toner particles produced by the kneading pulverization method in accordance with the intended use.

When the toner particles are produced by the kneading pulverization method, the shape thereof is amorphous and the surface composition thereof is not uniform in general. Although the shape and the surface composition of toner particles are subtly changed depending on the pulverizability of the toner material to be used and conditions for the pulverization process, it is difficult to intentionally control these aspects. Particularly, when a material with high pulverizability is used, the particles are more finely pulverized or the shape thereof is changed due to various stresses in a developing machine. As a result, in the case of a two-component developing agent, a problem arises that the finely pulverized toner particles adhere to the carrier surface to deteriorate the chargeability of the developing agent, and in the case of a one-component developing agent, a problem arises that a particle size distribution is widened and the finely pulverized toner particles are scattered, or developability is deteriorated as the toner shape is changed to cause deterioration of image quality.

On the other hand, in the case of a toner containing a release agent such as a wax, pulverization is liable to occur at a boundary between the binder resin and the release agent, and therefore, the release agent is sometimes exposed to the surface of the toner particles. In particular, when the toner is formed from a resin which has a high elasticity and is difficult to be pulverized and a brittle wax such as polyethylene, exposure of polyethylene to the surface of the toner particles is much seen. Although such a toner is advantageous in terms of a releasing property in fixing and cleaning of untransferred toner on a photoreceptor, the polyethylene on the surface of the toner particles is detached from the toner particles and easily transferred to a developing roll, a photoreceptor, a carrier or the like by mechanical force such as shearing force in the developing machine. Therefore, a problem arises that contamination of these members with polyethylene is easily caused and the reliability as a developing agent is lowered.

Under such circumstances, recently, as a method for producing a toner in which the shape and surface composition of toner particles are intentionally controlled, an emulsion polymerization aggregation method is proposed in JP-A-63-282752 and JP-A-6-250439. The emulsion polymerization aggregation method is a method for obtaining toner particles by separately preparing a resin dispersion liquid by emulsion polymerization and a coloring agent dispersion liquid in which a coloring agent is dispersed in a solvent, mixing these dispersion liquids to form aggregated particles with a size corresponding to a toner particle size, and fusing the aggregated particles by heating. According to this emulsion polymerization aggregation method, the toner shape can be arbitrarily controlled from amorphous to spherical shape by the selection of a heating temperature condition.

Further, in order to improve fixability, an attempt was made to intentionally control a molecular weight distribution. In the case of a resin having a low molecular weight, it is softened at a low temperature, therefore, fixing on paper can be achieved with low energy. However, it has low viscoelasticity, an offset phenomenon occurs when an energy of a certain level or higher is given. By using a resin having a high molecular weight in combination, a decrease in viscoelasticity at a high temperature can be retarded, and thus, the temperature at which the offset phenomenon occurs can be raised to a high temperature. In this manner, a plurality of resins having different molecular weights may be used by mixing, or one type of resin whose molecular weight distribution is intentionally controlled so as to have a multimodal molecular weight distribution may be used.

In the emulsion polymerization aggregation method, a toner can be obtained by subjecting a dispersion liquid containing at least resin fine particles and a dispersion liquid containing pigment fine particles to aggregation and fusion under a predetermined condition. However, since resin fine particles are synthesized by the emulsion polymerization method, there is a restriction on the type of resin, and the method cannot be applied to a polyester resin which is known to have a good fixability though the method is suitable for a styrene-acrylic copolymer. Further, there is a method for obtaining toner particles by a phase inversion emulsification method in which a pigment dispersion liquid and the like are added to a solution obtained by dissolving a polyester resin in an organic solvent and then water is added thereto, however, it is necessary to remove and recover the organic solvent. JP-A-9-311502 proposes a method for producing fine particles by mechanical stirring in an aqueous medium without using an organic solvent. However, it was necessary to feed a resin or the like in a molten state to a stirring device, and therefore, there was a problem that handling thereof was difficult. Further, with the use of this method, the degree of freedom for shape control was low, and the shape of toner particles could not be arbitrarily controlled from amorphous to spherical shape.

### SUMMARY

An object of the present invention is to provide a method for producing a developing agent capable of reducing the particle size, controlling the shape and forming a good image.

The invention provides a method for producing a developing agent including:

forming a kneaded material by preparing a toner material mixture containing a binder resin and a coloring agent and melt-kneading the toner material mixture;

forming a particulate mixture by pulverizing the kneaded material;

forming a dispersion liquid of the particulate mixture by dispersing the particulate mixture in an aqueous medium; and

forming fine particles having a particle diameter smaller than that of the particulate mixture by subjecting the dispersion liquid to mechanical shearing to finely pulverize the particulate mixture, wherein

to at least either one of the toner material mixture and the dispersion liquid of the particulate mixture, at least either one surfactant of an acid having a surface-active function and a salt having a surface-active function is added in an amount of from 0.1 to 5% by weight of the total weight of the developing agent.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a flowchart showing an example of a method for producing a developing agent of the invention.

FIG. 2 is a flowchart showing another example of a method for producing a developing agent of the invention.

FIG. 3 is a schematic diagram for illustrating a configuration of a twin-screw kneader.

### DETAILED DESCRIPTION

The method for producing a developing agent of the invention basically includes:

forming a kneaded material by preparing a toner material mixture containing a binder resin and a coloring agent and melt-kneading the toner material mixture;

forming a particulate mixture by pulverizing the kneaded material;

forming a dispersion liquid of the particulate mixture by dispersing the particulate mixture in an aqueous medium; and

forming fine particles having a particle diameter smaller than that of the particulate mixture by subjecting the dispersion liquid to mechanical shearing to finely pulverize the particulate mixture.

In the invention, to at least either one of the toner material mixture and the dispersion liquid of the particulate mixture, a surfactant is added in an amount of from 0.1 to 5% by weight of the total weight of the developing agent.

Examples of the surfactant to be used in the invention include acids having a surface-active function and salts having a surface-active function.

When a binder resin having an acid value is used, a pH adjusting agent is further added to the dispersion liquid of the particulate mixture, and either one or both of a surfactant and a pH adjusting agent can be added to the toner material mixture.

The pH adjusting agent is added in an amount which achieves 50 to 200% neutralization of the acid value of the binder resin.

According to the invention, by adding the surfactant to at least either one of the toner material mixture and the dispersion liquid of the particulate mixture, the dispersibility of the binder resin and the coloring agent becomes favorable due to the presence of at least one type of surfactant during kneading or fine pulverization.

Further, in the invention, as the surfactant, an acid having a surface-active function can be preferably used.

When the acid having a surface-active function is added to the binder resin, the melt viscosity of the binder resin is reduced, therefore, even if the binder resin is not heated to a high temperature, the viscosity can be reduced at a relatively low temperature. The binder resin such as polyester is easily hydrolyzed or the like when it is heated to a high temperature for melting, and further, as the heating temperature is higher, the energy cost is higher. Therefore, it is preferred that dispersion of the binder resin and the coloring agent and pulverization of the mixture containing the binder resin and the coloring agent are performed by reducing the melt viscosity using the acid having a surface-active function during kneading and/or mechanical shearing.

Further, according to the invention, by adding at least one or more types of the surfactants or at least one or more types of the pH adjusting agents to the toner material mixture and performing melt-kneading the resulting mixture, the fine particle dispersion liquid having a sharp and uniform particle size distribution and a uniform composition can be prepared with lower energy. Further, by subjecting the fine particle dispersion liquid to aggregation, uniform toner particles having a sharp and uniform particle size distribution can be prepared. Accordingly, a good image can be obtained as well as an effect such as further improvement of transferability.

Hereinafter, the invention will be described in further detail with reference to the drawings.

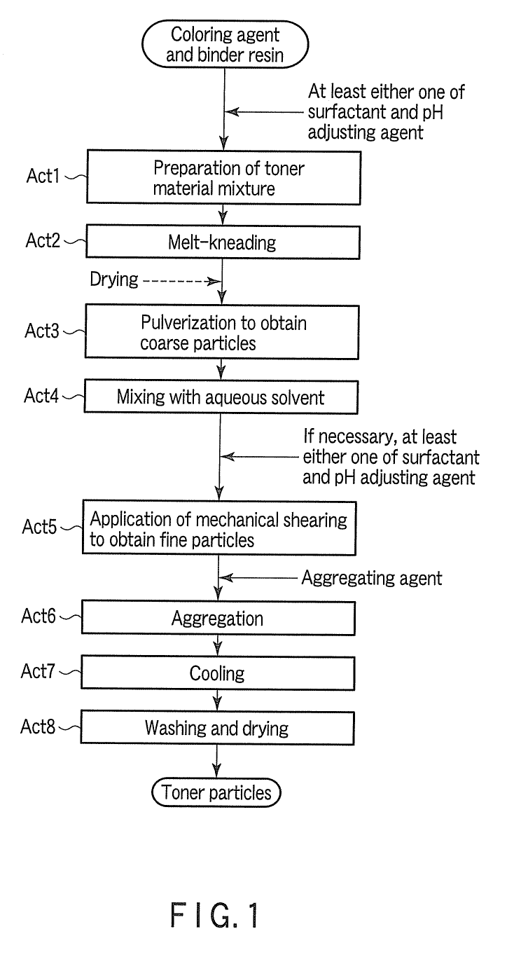

FIG. 1 is a flowchart showing one example of the method for producing a developing agent of the invention.

As shown in the drawing, a coloring agent and a binder resin such as polyester are prepared, and then, for example, at least either one of a surfactant and a pH adjusting agent is added thereto, whereby a toner material mixture is prepared (Act 1).

Subsequently, the toner material mixture is melt-kneaded while heating using a twin-screw kneader, whereby a kneaded material is obtained (Act 2).

Further, the kneaded material is, for example, dried under vacuum, followed by pulverization, whereby coarse particles are obtained (Act 3).

The thus obtained coarse particles are mixed with an aqueous medium (Act 4), and if necessary, at least either one of a surfactant and a pH adjusting agent is added, whereby a dispersion liquid of a particulate mixture is prepared. The total addition amount of the pH adjusting agent is adjusted to an amount which achieves 50 to 200% neutralization of the acid value of the binder resin. On the other hand, the total addition amount of the surfactant is adjusted to 0.1 to 5% by weight of the total weight of the developing agent.

The dispersion liquid of the particulate mixture is fed to a shearing device such as a high-pressure homogenizer NANO 3000, melted by heating to, for example, 160° C. and subjected to fine pulverization by applying shearing force at a treatment pressure of 150 MPa, followed by cooling, whereby fine particles are obtained (Act 5).

After the dispersion liquid containing the thus obtained fine particles is diluted, the fine particles are aggregated to a desired volume average particle diameter using at least one process selected from, for example, pH adjustment, addition of a surfactant, addition of a water-soluble metal oxide, addition of an organic solvent and temperature adjustment, whereby colored particles are obtained (Act 6).

To maintain the volume average particle diameter of the colored particles, a dispersant is added, and to control the shape thereof, the temperature of the mixture is raised to 90° C. and the mixture is left as such for 3 hours. After cooling the mixture (Act 7), the thus obtained colored particles are washed using a centrifuge until the electrical conductivity of washing water after washing becomes 50 μS/cm. Thereafter, the resulting colored particles are dried using a vacuum dryer until the water content becomes 0.3% by weight (Act 8). After drying, external additives, for example, 2 parts by weight of hydrophobic silica, 0.5 parts by weight of titanium oxide and the like are adhered to the surface of the colored particles, whereby a developing agent can be obtained.

Incidentally, in the flowchart, at least either one of the surfactant and the pH adjusting agent is added to the toner material mixture, however, in the invention, it is optional whether the surfactant and the pH adjusting agent are added to the toner material mixture as long as at least the surfactant is finally contained in the dispersion liquid of the particulate mixture.

Further, the surfactant can be added along with water as an aqueous solution to the toner material mixture. Further, at this time, the water content in the toner material mixture is from 10 to 40% by weight, and the melt-kneading procedure can be adjusted such that the water content in the kneaded material falls within a range of from 0.1 to 5% by weight.

Alternatively, the surfactant and the pH adjusting agent can be added along with water as an aqueous solution to the toner material mixture. Similarly, at this time, the water content in the toner material mixture is from 10 to 40% by weight, and the melt-kneading procedure can be adjusted such that the water content in the kneaded material falls within a range of from 0.1 to 5% by weight.

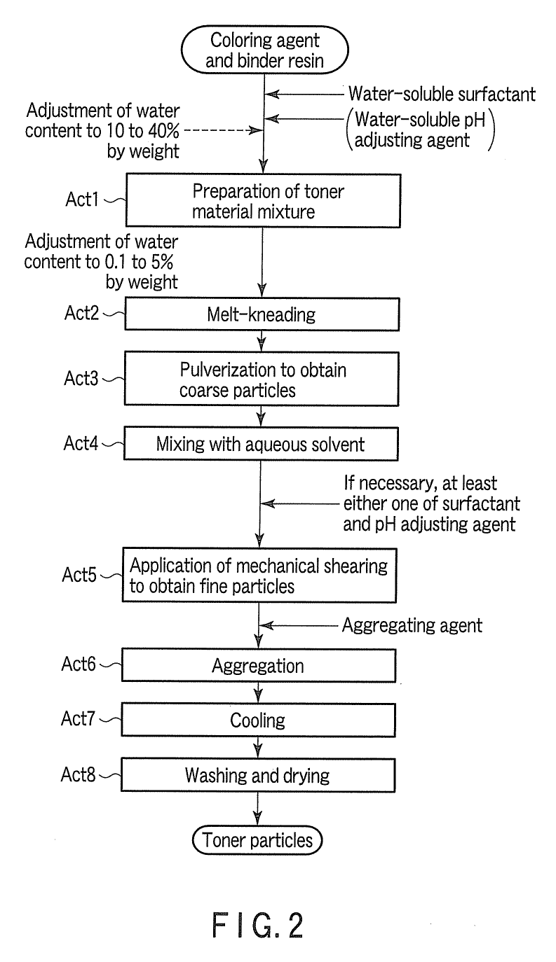

FIG. 2 is a flowchart showing another example of the method for producing a developing agent of the invention.

As shown in the drawing, a coloring agent and a binder resin such as polyester are prepared, and then, for example, at least either one of an aqueous solution of a surfactant and an aqueous solution of a pH adjusting agent is added thereto. A portion thereof is collected as a sample and it is confirmed that the water content falls within a range of from 10 to 40% by weight, whereby a toner material mixture is prepared (Act 1).

Subsequently, the toner material mixture is melt-kneaded while heating using a twin-screw kneader. At this time, by adjusting, for example, the heating temperature of the twin-screw kneader so as to discharge excess water from a vent as water vapor, a kneaded material having a water content of from 0.1 to 5% by weight is obtained (Act 2).

Incidentally, the heating temperature may be appropriately adjusted while collecting a sample of the kneaded material during kneading and measuring the water content therein.

Further, the kneaded material is, for example dried under vacuum, followed by pulverization, whereby coarse particles are obtained (Act 3).

The thus obtained coarse particles are mixed with an aqueous medium (Act 4), and if necessary, at least either one of a surfactant and a pH adjusting agent is added, whereby a dispersion liquid of a particulate mixture is prepared. The total addition amount of the pH adjusting agent is adjusted to an amount which achieves 50 to 200% neutralization of the acid value of the binder resin. On the other hand, the total addition amount of the surfactant can be adjusted to 0.1 to 5% by weight of the total weight of the developing agent.

The dispersion liquid of the particulate mixture is fed to a shearing device such as a high-pressure homogenizer NANO 3000, melted by heating to, for example, 160° C. and subjected to fine pulverization by applying shearing force at a treatment pressure of 150 MPa, followed by cooling, whereby fine particles are obtained (Act 5).

After the dispersion liquid containing the thus obtained fine particles is diluted, the fine particles are aggregated to a desired volume average particle diameter using at least one process selected from, for example, pH adjustment, addition of a surfactant, addition of a water-soluble metal oxide, addition of an organic solvent and temperature adjustment, whereby colored particles are obtained (Act 6).

To maintain the volume average particle diameter of the colored particles, a dispersant is added, and to control the shape thereof, the temperature of the mixture is raised to, for example, 90° C. and the mixture is left as such for 3 hours. After cooling the mixture (Act 7), the thus obtained colored particles are washed using a centrifuge until the electrical conductivity of washing water after washing becomes 50 μS/cm. Thereafter, the resulting colored particles are dried using a vacuum dryer until the water content becomes 0.3% by weight (Act 8). After drying, external additives, for example, 2 parts by weight of hydrophobic silica, 0.5 parts by weight of titanium oxide and the like are adhered to the surface of the colored particles, whereby a developing agent is obtained.

Examples of the binder resin to be used in the invention include styrene resins such as polystyrene, styrene/butadiene copolymers and styrene/acrylic copolymers; ethylene resins such as polyethylene, polyethylene/vinyl acetate copolymers, polyethylene/norbornene copolymers and polyethylene/vinyl alcohol copolymers; polyester resins, acrylic resins, phenol resins, epoxy resins, allyl phthalate resins, polyamide resins and maleic resins. These resins may be used alone or in combination of two or more types thereof. However, from the viewpoint of fixability or the like, polyester resins can be preferably used in the invention.

As the coloring agent to be used in the invention, a carbon black, an organic or inorganic pigment or dye, or the like is used. There is no special restriction, however, examples of the carbon black include acetylene black, furnace black, thermal black, channel black and Ketjen black. Further, examples of the pigment and dye include first yellow G, benzidine yellow, indofast orange, irgazine red, naphthol azo, carmen FB, permanent bordeaux FRR, pigment orange R, lithol red 2G, lake red C, rhodamine FB, rhodamine B lake, phthalocyanine blue, pigment blue, brilliant green B, phthalocyanine green, and quinacridone. Preferred examples of a yellow pigment include C.I. Pigment Yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183, and 185, and C.I. Vat Yellow 1, 3, and 20. These can be used alone or in admixture. Preferred examples of a magenta pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209, and 238, C.I. Pigment Violet 19, and C.I. Vat Red 1, 2, 10, 13, 15, 23, 29, and 35. These can be used alone or in admixture. Preferred examples of a cyan pigment include C.I. Pigment Blue 2, 3, 15, 16, and 17, C.I. Vat Blue 6, and C.I. Acid Blue 45. These can be used alone or in admixture.

In the invention, a wax may be blended. Examples of the wax include aliphatic hydrocarbon waxes such as low molecular weight polyethylene, low molecular weight polypropylene, polyolefin copolymers, polyolefin waxes, microcrystalline waxes, paraffin waxes and Fischer-Tropsch waxes; oxides of an aliphatic hydrocarbon wax such as polyethylene oxide waxes or block copolymers thereof; vegetable waxes such as candelilla wax, carnauba wax, Japan wax, jojoba wax and rice wax; animal waxes such as bees wax, lanolin and whale wax; mineral waxes such as ozokerite, ceresin and petrolatum; waxes containing, as the major component, a fatty acid ester such as montanic acid ester wax and castor wax; and deoxidation products resulting from deoxidization of a part or the whole of a fatty acid ester such as deoxidized carnauba wax. Further, saturated linear fatty acids such as palmitic acid, stearic acid, montanic acid and long-chain alkyl carboxylic acids having a long-chain alkyl group; unsaturated fatty acids such as brassidic acid, eleostearic acid and parinaric acid; saturated alcohols such as stearyl alcohol, eicosyl alcohol, behenyl alcohol, carnaubyl alcohol, ceryl alcohol, melissyl alcohol and long-chain alkyl alcohols having a long-chain alkyl group; polyhydric alcohols such as sorbitol; fatty acid amides such as linoleic acid amide, oleic acid amide and lauric acid amide; saturated fatty acid bisamides such as methylenebisstearic acid amide, ethylenebiscaprylic acid amide, ethylenebislauric acid amide and hexamethylenebisstearic acid amide; unsaturated fatty acid amides such as ethylenebisoleic acid amide, hexamethylenebisoleic acid amide, N,N′-dioleyladipic acid amide and N,N′-dioleylsebaccic acid amide; aromatic bisamides such as m-xylenebisstearic acid amide and N,N′-distearylisophthalic acid amide; fatty acid metal salts (generally called metallic soaps) such as calcium stearate, calcium laurate, zinc stearate and magnesium stearate; waxes obtained by grafting of a vinyl monomer such as styrene or acrylic acid on an aliphatic hydrocarbon wax; partially esterified products of a fatty acid and a polyhydric alcohol such as behenic acid monoglyceride; and methyl ester compounds having a hydroxyl group obtained by hydrogenation of a vegetable fat and oil can be exemplified.

In the invention, a charge controlling agent or the like for controlling a frictional charge quantity may be blended. As the charge controlling agent, a metal-containing azo compound is used, and a complex or a complex salt in which the metal element is iron, cobalt or chromium, or a mixture thereof is preferred. Further, a metal-containing salicylic acid derivative compound can also be used, and a complex or a complex salt in which the metal element is zirconium, zinc, chromium or boron, or a mixture thereof is preferred.

In the invention, a surfactant for dispersing the toner composition in the binder resin and water is blended. The surfactant is not particularly limited and an anionic surfactant such as a sulfate ester salt type, a sulfonate salt type, a phosphate ester type or a soap type; a cationic surfactant such as an amine salt type or a quaternary ammonium salt type; or a nonionic surfactant such as a polyethylene glycol type, an alkyl phenol ethylene oxide adduct type or a polyhydric alcohol type can be used.

From the viewpoint that the toner composition is uniformly dispersed in water, sulfonate salt-type anionic surfactants are preferred. Specifically, dodecyl benzene sulfonates are preferred.

Further, the surfactant to be used in the invention includes both salts having a surface-active function such as the above-mentioned sulfate ester salt types and sulfonate salt types, and acids having a surface-active function such as sulfate ester types and sulfonic acid types.

The acid having a surface-active function has a chemical structure comprising a hydrophobic group and a hydrophilic group, has a structure of an acid in which at least a part of a hydrophilic group comprises a proton, and has functions to emulsify the toner composition and to reduce the melt viscosity of the polyester resin. Examples of the acid having a surface-active function include alkyl benzene sulfonic acids, alkyl sulfonic acids, alkyl disulfonic acids, alkyl phenol sulfonic acids, alkyl naphthalene sulfonic acids, alkyl tetralin sulfonic acids, alkyl allyl sulfonic acids, petroleum sulfonic acids, alkyl benzimidazol sulfonic acids, higher alcohol ether sulfonic acids, alkyl diphenyl sulfonic acids, long-chain alkyl sulfate esters, higher alcohol sulfate esters, higher alcohol ether sulfate esters, higher fatty acid amide alkylol sulfate esters, higher fatty acid amide alkylated sulfate esters, sulfated fatty acids, sulfosuccinate esters and resin acid alcohol sulfuric acids.

The salt having a surface-active function has a chemical structure comprising a hydrophobic group and a hydrophilic group and has a function to emulsify the toner composition. Examples of the salt having a surface-active function include anionic surfactants such as sulfate ester salt types, sulfonate salt types and phosphate ester types; cationic surfactants such as amine salt types and quaternary ammonium salt types; nonionic surfactants such as polyethylene glycol types, alkyl phenol ethylene oxide adduct types and alcohol types; and amphoteric surfactants such as alkyl betaine types and alkyl amine oxide types.

These acids having a surface-active function and salts having a surface-active function may be used alone or in combination of two or more types thereof.

Among these, the anionic surfactants and the like are preferred in consideration of the function to emulsify and disperse the toner composition, and the acids having a surface active function are preferred in consideration of the melt viscosity reducing effect.

The addition amount of these surfactants can be set to 0.1 to 5 parts by weight, more preferably 0.5 to not more than 3 parts by weight based on 100 parts by weight of the toner composition. If the addition amount is less than 0.1 parts by weight, an effect of the surfactant on dispersion of the toner composition is insufficient, and moreover, a sufficient melt viscosity reducing effect cannot be obtained. Even if the surfactant is added in an amount more than 5 parts by weight, the amount of the surfactant eventually remaining in the toner increases, and therefore a desired toner characteristic cannot be obtained.

Further, in the invention, a pH adjusting agent may be blended. The pH adjusting agent is not particularly limited as long as it can adjust the pH to a desired value, however, amine compounds are preferred. Examples of the amine compound include dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane and N,N-diethyl-1,3-diaminopropane. With the amine compound, the carboxyl group at the end of the polyester resin is neutralized, and the self-dispersibility of the polyester resin is improved.

When the pH adjusting agent is added, the addition amount thereof can be set to an amount which achieves 50 to 200%, more preferably 75 to 150% neutralization of the acid value of the polyester resin to be used. If the addition amount is less than the amount which achieves 50% neutralization of the acid value of the polyester resin, neutralization is not sufficient and there is a tendency that the self-dispersibility of the polyester resin cannot be improved. When the addition amount is more than the amount which achieves 200% neutralization of the acid value of the polyester resin, although sufficient self-dispersibility can be obtained, hydrolysis of the polyester resin is caused during melt-kneading and fine pulverization, therefore, desired fixability of the toner as the final product cannot be maintained.

The surfactant and the pH adjusting agent are preferably incorporated before fine pulverization for improving the dispersibility of the toner composition and reducing the melt viscosity, however, more preferably, the acid having a surface-active function is added before melt-kneading. Of course, the surfactant and the pH adjusting agent may be added in divided portions. By adding the acid having a surface-active function before melt-kneading, a desired melt viscosity can be obtained at a lower temperature, and therefore, the toner composition can be uniformly melt-kneaded at a lower temperature. Accordingly, the material can be uniformly dispersed with low energy. Further, by doing this, fine pulverization can be achieved at a lower temperature with lower energy. In consideration of hydrolysis of the polyester resin, it is most preferred that the acid having a surface-active function is added before melt-kneading, the pH adjusting agent is added before fine pulverization, and if necessary, the surfactant and the acid having a surface-active function are preferably added additionally.

In the invention, a mixed material containing at least the binder resin and the coloring agent and at least either one of the surfactant and the pH adjusting agent is kneaded using a kneader. The kneader is not particularly limited as long as it can perform melt-kneading, and examples thereof include a single-screw extruder, a twin-screw extruder, a pressure kneader, a Banbury mixer and a Brabender mixer. Specific examples thereof include FCM (manufactured by Kobe Steel, Ltd.), NCM (manufactured by Kobe Steel, Ltd.), LCM (manufactured by Kobe Steel, Ltd.), ACM (manufactured by Kobe Steel, Ltd.), KTX (manufactured by Kobe Steel, Ltd.), GT (manufactured by Ikegai, Ltd.), PCM (manufactured by Ikegai, Ltd.), TEX (manufactured by the Japan Steel Works, Ltd.), TEM (manufactured by Toshiba Machine Co., Ltd.), ZSK (manufactured by Warner K.K.) and KNEADEX (manufactured by Mitsui Mining Co., Ltd.).

A device capable of providing mechanical shearing force (hereinafter referred to as “shearing device”) to be used in the invention is not particularly limited, and examples thereof include mediumless stirring devices such as ULTRA TURRAX (manufactured by IKA Japan K.K.), T.K. AUTO HOMO MIXER (manufactured by PRIMIX Corporation), T.K. PIPELINE HOMO MIXER (manufactured by PRIMIX Corporation), T.K. FILMICS (manufactured by PRIMIX Corporation), CLEAR MIX (manufactured by M TECHNIQUE Co., Ltd.), CLEAR SS5 (manufactured by M TECHNIQUE Co., Ltd.), CAVITRON (manufactured by EUROTEC, Ltd.) and FINE FLOW MILL (manufactured by Pacific Machinery & Engineering Co., Ltd.); medium stirring devices such as VISCO MILL (manufactured by Aimex Co., Ltd.), APEX MILL (manufactured by Kotobuki Industries Co., Ltd.), STAR MILL (manufactured by Ashizawa Finetech Co., Ltd.), DCP SUPERFLOW (manufactured by Nippon Eirich Co., Ltd.), MP MILL (manufactured by Inoue Manufacturing Co., Ltd.), SPIKE MILL (manufactured by Inoue Manufacturing Co., Ltd.), MIGHTY MILL (manufactured by Inoue Manufacturing Co., Ltd.), and SC MILL (manufactured by Mitsui Mining Co., Ltd.); NANO 3000 (manufactured by Beryu Co., Ltd.), Nanomizer (manufactured by Yoshida Kikai Co., Ltd.), Starburst (manufactured by Sugino Machine Limited), Microfluidizer (manufactured by Mizuho Industry Co., Ltd.) and Homogenizer (manufactured by Sanwa Machinery Trading Co., Ltd.).

In the invention, the mixed material or kneaded material containing at least the binder resin and the coloring agent is finely pulverized while heating using the shearing device, and after the fine pulverization, the resulting material may be once cooled to a desired temperature, or the temperature of the material may be set to a desired temperature at which aggregation is carried out.

In the invention, when the fine particles are aggregated, a water-soluble metal salt or a pH adjusting agent may be used. Examples of the water-soluble metal salt include metal salts such as sodium chloride, calcium chloride, calcium nitrate, barium chloride, magnesium chloride, zinc chloride, magnesium sulfate, aluminum chloride and aluminum sulfate; and inorganic metal salt polymers such as poly(aluminum chloride), poly(aluminum hydroxide) and calcium polysulfide. The pH adjusting agent is not particularly limited as long as it can adjust the pH to a desired value. However, the fine particles are stabilized by an alkali, the pH adjusting agent is preferably an acid such as hydrochloric acid or acetic acid. The stability of the fine particles stabilized by an alkali is destroyed and aggregation can be accelerated by the acid.

In the invention, when the fine particles are aggregated, an organic solvent may be used. Examples of the organic solvent include alcohols such as methanol, ethanol, 1-propanol, 2-propanol, 2-methyl-2-propanol, 2-methoxyethanol, 2-ethoxyethanol and 2-butoxyethanol; acetonitrile and 1,4-dioxane.

In the invention, in order to adjust the fluidity or chargeability of the toner particles, inorganic fine particles may be externally added and mixed in an amount of from 0.01 to 10% by weight based on the toner particles. As such inorganic fine particles, silica, titania, alumina, strontium titanate, tin oxide and the like can be used alone or in admixture of two or more kinds thereof. It is preferred that as the inorganic fine particles, inorganic fine particles surface-treated with a hydrophobizing agent are used from the viewpoint of improvement of environmental stability. Further, other than such inorganic oxides, resin fine particles having a particle size of 1 μm or less may be externally added for improving the cleaning property.

Examples of a mixing machine for the inorganic fine particles and the like include Henschel mixer (manufactured by Mitsui Mining Co., Ltd.), Super mixer (manufactured by Kawata Mfg. Co., Ltd.), Libocone (manufactured by Okawara Mfg. Co., Ltd.), Nauta mixer (manufactured by Hosokawa Micron, Co., Ltd.), Turbulizer (manufactured by Hosokawa Micron, Co., Ltd.), Cyclomix (manufactured by Hosokawa Micron, Co., Ltd.), Spiral Pin Mixer (manufactured by Pacific Machinery & Engineering Co., Ltd.), and Lodige Mixer (manufactured by Matsubo Corporation).

In the invention, further, coarse particles and the like may be sieved. Examples of a sieving device to be used for sieving include ULTRA SONIC (manufactured by Koei Sangyo Co., Ltd.), GYRO SHIFTER (manufactured by Tokuju Corporation), VIBRASONIC SYSTEM (manufactured by Dalton Co., Ltd.), SONICLEAN (manufactured by Shinto Kogyo K.K.), TURBO SCREENER (manufactured by Turbo Kogyo Co., Ltd.), MICRO SHIFTER (manufactured by Makino Mfg. Co., Ltd.), and a circular vibrating sieve.

Hereinafter, the invention will be specifically described with reference to Examples.

### EXAMPLE 1

90 parts by weight of a polyester resin, 5 parts by weight of a cyan pigment, 4 parts by weight of an ester wax and 1 part by weight of a charge controlling agent were mixed. Then, 99 parts by weight of the resulting mixture and 1 part by weight of sodium dodecyl benzene sulfonate were mixed, whereby a toner material mixture was prepared.

Subsequently, the toner material mixture was melt-kneaded using a twin-screw kneader whose temperature was set to 130° C., whereby a kneaded material was obtained.

When the thus obtained kneaded material was melted and spread on a slide glass and observed with a light microscope, coarse particles of the pigment with a size of 1 μm or more were not observed.

The kneaded material was further pulverized to a size less than 100 μm using a bantam mill. 30 parts by weight of the thus pulverized kneaded material, 0.06 parts by weight of sodium dodecyl benzene sulfonate, 2 parts by weight (corresponding to an amount which achieves 100% neutralization) of an amine compound and 67.94 parts by weight of ion exchanged water were mixed and melted by heating to 160° C. using a high-pressure homogenizer NANO 3000 and subjected to shearing force at a treatment pressure of 150 MPa, followed by cooling, whereby a fine particle dispersion liquid was obtained. The volume average particle diameter of the thus obtained fine particles was measured using SALD-7000 (manufactured by Shimadzu Corporation) and found to be 0.82 μm. The thus obtained fine particle dispersion liquid was diluted, and an aqueous solution of hydrochloric acid was added thereto, and the temperature of the mixture was gradually raised to 70° C. to aggregate the fine particles to a desired volume average particle diameter, whereby colored particles were obtained. To maintain the volume average particle diameter of the colored particles, a dispersant was added thereto and to control the shape of the colored particles, the temperature of the mixture was raised to 90° C., and the mixture was left as such for 3 hours. After cooling the mixture, the thus obtained colored particles were washed using a centrifuge until the electrical conductivity of washing water after washing became 50 μS/cm. Thereafter, the resulting colored particles were dried using a vacuum dryer until the water content became 0.3 wt %. After drying, 2 parts by weight of hydrophobic silica and 0.5 parts by weight of titanium oxide were adhered to the surface of the colored particles, whereby an electrophotographic toner was obtained. The volume average particle diameter of the thus obtained electrophotographic toner was measured using a coulter counter (manufactured by Beckman Coulter, Inc.) and found to be 5.0 μm, and the circularity thereof was measured using FPIA (manufactured by Sysmex Corporation) and found to be 0.98. Further, the yield was 98%. This toner is designated as Toner A.

### EXAMPLE 2

90 parts by weight of a polyester resin, 5 parts by weight of a cyan pigment, 4 parts by weight of an ester wax and 1 part by weight of a charge controlling agent were mixed. Then, 98 parts by weight of the resulting mixture and 2 parts by weight (corresponding to an amount which achieves 100% neutralization) of an amine compound were mixed and processed using a twin-screw kneader whose temperature was set to 140° C., whereby a kneaded material was obtained.

When the thus obtained kneaded material was melted and spread on a slide glass and observed with a light microscope, coarse particles of the pigment with a size of 1 μm or more were not observed.

The kneaded material was further pulverized to a size less than 100 μm using a bantam mill. 30 parts by weight of the thus pulverized kneaded material, 0.3 parts by weight of sodium dodecyl benzene sulfonate and 69.7 parts by weight of ion exchanged water were mixed and melted by heating to 160° C. using a high-pressure homogenizer NANO 3000 and subjected to shearing force at a treatment pressure of 150 MPa, followed by cooling, whereby a fine particle dispersion liquid was obtained. The volume average particle diameter of the thus obtained fine particles was measured using SALD-7000 (manufactured by Shimadzu Corporation) and found to be 0.65 μm. The thus obtained fine particle dispersion liquid was diluted, and an aqueous solution of hydrochloric acid was added thereto, and the temperature of the mixture was gradually raised to 70° C. to aggregate the fine particles to a desired volume average particle diameter, whereby colored particles could be obtained. To maintain the volume average particle diameter of the colored particles, a dispersant was added thereto, and to control the shape of the colored particles, the temperature of the mixture was raised to 90° C., and the mixture was left as such for 3 hours. After cooling the mixture, the thus obtained colored particles were washed using a centrifuge until the electrical conductivity of washing water after washing became 50 μS/cm. Thereafter, the resulting colored particles were dried using a vacuum dryer until the water content became 0.3 wt %. After drying, 2 parts by weight of hydrophobic silica and 0.5 parts by weight of titanium oxide were adhered to the surface of the colored particles, whereby a desired electrophotographic toner could be obtained. The volume average particle diameter of the thus obtained electrophotographic toner was measured using a coulter counter (manufactured by Beckman Coulter, Inc.) and found to be 4.8 μm, and the circularity thereof was measured using FPIA (manufactured by Sysmex Corporation) and found to be 0.97. Further, the yield was 95%. This toner is designated as Toner B.

### EXAMPLE 3

90 parts by weight of a polyester resin, 5 parts by weight of a cyan pigment, 4 parts by weight of an ester wax and 1 part by weight of a charge controlling agent were mixed. Then, 99 parts by weight of the resulting mixture and 0.5 parts by weight of dodecyl benzene sulfonic acid were mixed and processed using a twin-screw kneader whose temperature was set to 110° C., whereby a kneaded material was obtained.

When the thus obtained kneaded material was melted and spread on a slide glass and observed with a light microscope, coarse particles of the pigment with a size of 1 μm or more were not observed.

The kneaded material was further pulverized to a size less than 100 μm using a bantam mill. 30 parts by weight of the thus pulverized kneaded material, 0.5 parts by weight of sodium dodecyl benzene sulfonate, 2 parts by weight of an amine compound and 67.94 parts by weight of ion exchanged water were mixed and melted by heating to 140° C. using a high-pressure homogenizer NANO 3000 and subjected to shearing force at a treatment pressure of 150 MPa, followed by cooling, whereby a fine particle dispersion liquid was obtained. The volume average particle diameter of the thus obtained fine particles was measured using SALD-7000 (manufactured by Shimadzu Corporation) and found to be 0.7 μm. The thus obtained fine particle dispersion liquid was diluted, and an aqueous solution of hydrochloric acid was added thereto, and the temperature of the mixture was gradually raised to 70° C. to aggregate the fine particles to a desired volume average particle diameter, whereby colored particles could be obtained. To maintain the volume average particle diameter of the colored particles, a dispersant was added thereto, and to control the shape of the colored particles, the temperature of the mixture was raised to 90° C., and the mixture was left as such for 3 hours. After cooling the mixture, the thus obtained colored particles were washed using a centrifuge until the electrical conductivity of washing water after washing became 50 μS/cm. Thereafter, the resulting colored particles were dried using a vacuum dryer until the water content became 0.3 wt %. After drying, 2 parts by weight of hydrophobic silica and 0.5 parts by weight of titanium oxide were adhered to the surface of the colored particles, whereby a desired electrophotographic toner could be obtained. The volume average particle diameter of the thus obtained electrophotographic toner was measured using a coulter counter (manufactured by Beckman Coulter, Inc.) and found to be 5.0 μm, and the circularity thereof was measured using FPIA (manufactured by Sysmex Corporation) and found to be 0.98. Further, the yield was 98%. This toner is designated as Toner C.

### COMPARATIVE EXAMPLE 1

90 parts by weight of a polyester resin, 5 parts by weight of a cyan pigment, 4 parts by weight of an ester wax and 1 part by weight of a charge controlling agent were mixed. Then, the resulting mixture was processed using a twin-screw kneader whose temperature was set to 140° C., whereby a kneaded material was obtained. When the thus obtained kneaded material was melted and spread on a slide glass and observed with a light microscope, numerous coarse particles of the pigment with a size of 1 μm or more were observed.

The kneaded material was further pulverized to a size less than 100 μm using a bantam mill. 30 parts by weight of the thus pulverized kneaded material, 0.3 parts by weight of sodium dodecyl benzene sulfonate, 2 parts by weight of an amine compound and 67.7 parts by weight of ion exchanged water were mixed and melted by heating to 180° C. using a high-pressure homogenizer NANO 3000 and subjected to shearing force at a treatment pressure of 150 MPa, followed by cooling, whereby a fine particle dispersion liquid was obtained. The volume average particle diameter of the thus obtained fine particles was measured using SALD-7000 (manufactured by Shimadzu Corporation) and found to be 0.82 μm. The thus obtained fine particle dispersion liquid was diluted, and an aqueous solution of hydrochloric acid was added thereto, and the temperature of the mixture was gradually raised to 70° C. to aggregate the fine particles to a desired volume average particle diameter, whereby colored particles could be obtained. To maintain the volume average particle diameter of the colored particles, a dispersant was added thereto, and to control the shape of the colored particles, the temperature of the mixture was raised to 90° C., and the mixture was left as such for 3 hours. After cooling the mixture, the thus obtained colored particles were washed using a centrifuge until the electrical conductivity of washing water after washing became 50 μS/cm. Thereafter, the resulting colored particles were dried using a vacuum dryer until the water content became 0.3 wt %. After drying, 2 parts by weight of hydrophobic silica and 0.5 parts by weight of titanium oxide were adhered to the surface of the colored particles, whereby a desired electrophotographic toner could be obtained. The volume average particle diameter of the thus obtained electrophotographic toner was measured using a coulter counter (manufactured by Beckman Coulter, Inc.) and found to be 6.3 μm, and the circularity thereof was measured using FPIA (manufactured by Sysmex Corporation) and found to be 0.90. Further, the yield was 86%. This toner is designated as Toner D.

### COMPARATIVE EXAMPLE 2

90 parts by weight of a polyester resin, 5 parts by weight of a cyan pigment, 4 parts by weight of an ester wax and 1 part by weight of a charge controlling agent were mixed. Then, 99 parts by weight of the resulting mixture and 0.5 parts by weight of dodecyl benzene sulfonic acid were mixed and processed using a twin-screw kneader whose temperature was set to 110° C., whereby a kneaded material was obtained. When the thus obtained kneaded material was melted and spread on a slide glass and observed with a light microscope, coarse particles of the pigment with a size of 1 μm or more were not observed.

The kneaded material was further pulverized to a size less than 100 μm using a bantam mill. 30 parts by weight of the thus pulverized kneaded material, 0.06 parts by weight of sodium dodecyl benzene sulfonate, 2 parts by weight of an amine compound and 67.7 parts by weight of ion exchanged water were mixed and melted by heating to 140° C. using a high-pressure homogenizer NANO 3000 and subjected to shearing force at a treatment pressure of 150 MPa, followed by cooling, whereby a fine particle dispersion liquid was obtained. The volume average particle diameter of the thus obtained fine particles was measured using SALD-7000 (manufactured by Shimadzu Corporation) and found to be 0.13 μm. The thus obtained fine particle dispersion liquid was diluted, and an aqueous solution of hydrochloric acid was added thereto, and the temperature of the mixture was gradually raised to 70° C., however, aggregated particles could not be produced.

### COMPARATIVE EXAMPLE 3

90 parts by weight of a polyester resin, 5 parts by weight of a cyan pigment, 4 parts by weight of an ester wax and 1 part by weight of a charge controlling agent were mixed. Then, 99 parts by weight of the resulting mixture and 0.5 parts by weight of dodecyl benzene sulfonic acid were mixed and processed using a twin-screw kneader whose temperature was set to 110° C., whereby a kneaded material was obtained. When the thus obtained kneaded material was melted and spread on a slide glass and observed with a light microscope, coarse particles of the pigment with a size of 1 μm or more were not observed.

The kneaded material was further pulverized to a size less than 100 μm using a bantam mill. 30 parts by weight of the thus pulverized kneaded material, 0.06 parts by weight of sodium dodecyl benzene sulfonate, 2 parts by weight of an amine compound and 67.7 parts by weight of ion exchanged water were mixed and melted by heating to 140° C. using a high-pressure homogenizer NANO 3000 and subjected to shearing force at a treatment pressure of 150 MPa, followed by cooling, whereby a fine particle dispersion liquid was obtained. The volume average particle diameter of the thus obtained fine particles was measured using SALD-7000 (manufactured by Shimadzu Corporation) and found to be 0.13 μm. The thus obtained fine particle dispersion liquid was diluted, and an aqueous solution of aluminum sulfate was added thereto, and the temperature of the mixture was gradually raised to 70° C. to aggregate the fine particles to a desired volume average particle diameter, whereby colored particles could be obtained. To maintain the volume average particle diameter of the colored particles, a dispersant was added thereto, and to control the shape of the colored particles, the temperature of the mixture was raised to 90° C., and the mixture was left as such for 3 hours. After cooling the mixture, the thus obtained colored particles were washed using a centrifuge until the electrical conductivity of washing water after washing became 50 μS/cm. Thereafter, the resulting colored particles were dried using a vacuum dryer until the water content became 0.3 wt %. After drying, 2 parts by weight of hydrophobic silica and 0.5 parts by weight of titanium oxide were adhered to the surface of the colored particles, whereby a desired electrophotographic toner was obtained. The volume average particle diameter of the thus obtained electrophotographic toner was measured using a coulter counter (manufactured by Beckman Coulter, Inc.) and found to be 4.9 μm, and the circularity thereof was measured using FPIA (manufactured by Sysmex Corporation) and found to be 0.94. Further, the yield was 86%. This toner is designated as Toner E.

### COMPARATIVE EXAMPLE 4

90 parts by weight of a polyester resin, 5 parts by weight of a cyan pigment, 4 parts by weight of an ester wax and 1 part by weight of a charge controlling agent were mixed. Then, 98 parts by weight of the resulting mixture and 4.5 parts by weight (corresponding to an amount which achieves 225% neutralization) of an amine compound were mixed and processed using a twin-screw kneader whose temperature was set to 140° C., whereby a kneaded material was obtained. When the thus obtained kneaded material was melted and spread on a slide glass and observed with a light microscope, coarse particles of the pigment with a size of 1 μm or more were not observed.

The kneaded material was further pulverized to a size less than 100 μm using a bantam mill. 30 parts by weight of the thus pulverized kneaded material, 0.3 parts by weight of sodium dodecyl benzene sulfonate and 69.7 parts by weight of ion exchanged water were mixed and melted by heating to 160° C. using a high-pressure homogenizer NANO 3000 and subjected to shearing force at a treatment pressure of 150 MPa, followed by cooling, whereby a fine particle dispersion liquid was obtained. The volume average particle diameter of the thus obtained fine particles was measured using SALD-7000 (manufactured by Shimadzu Corporation) and found to be 0.45 μm. The thus obtained fine particle dispersion liquid was diluted, and an aqueous solution of hydrochloric acid was added thereto, and the temperature of the mixture was gradually raised to 70° C. to aggregate the fine particles to a desired volume average particle diameter, whereby colored particles could be obtained. To maintain the volume average particle diameter of the colored particles, a dispersant was added thereto, and to control the shape of the colored particles, the temperature of the mixture was raised to 90° C., and the mixture was left as such for 3 hours. After cooling the mixture, the thus obtained colored particles were washed using a centrifuge until the electrical conductivity of washing water after washing became 50 μS/cm. Thereafter, the resulting colored particles were dried using a vacuum dryer until the water content became 0.3 wt %. After drying, 2 parts by weight of hydrophobic silica and 0.5 parts by weight of titanium oxide were adhered to the surface of the colored particles, whereby an electrophotographic toner was obtained. The volume average particle diameter of the thus obtained electrophotographic toner was measured using a coulter counter (manufactured by Beckman Coulter, Inc.) and found to be 5.2 μm, and the circularity thereof was measured using FPIA (manufactured by Sysmex Corporation) and found to be 0.97. Further, the yield was 95%. This toner is designated as Toner F.

### COMPARATIVE EXAMPLE 5

When the same procedure as in Example 1 was performed except that the addition amount of sodium dodecyl benzene sulfonate added before melt-kneading was changed to 0, fine particles having a broad particle size distribution with an average particle diameter of 2.5 μm could be produced. When toner particles were produced in the same manner as in Example 1 using these fine particles, the resulting toner particles had a broad particle size distribution with an average particle diameter of 18.5 μm. The circularity of this toner was 0.91. This toner is designated as Toner G.

### COMPARATIVE EXAMPLE 6

When the same procedure as in Example 1 was performed except that the addition amount of an amine compound added before fine pulverization was changed to 0.5 parts by weight (corresponding to an amount which achieves 25% neutralization), fine particles having a broad particle size distribution with an average particle diameter of 2.8 μm could be produced. When toner particles were produced in the same manner as in Example 1 using these fine particles, the resulting toner particles had a broad particle size distribution with an average particle diameter of 23.4 μm. The circularity of this toner was 0.93. This toner is designated as Toner H.

### EXAMPLE 4

When toner particles were produced in the same manner as in Example 1 except that the addition of dodecyl benzene sulfonic acid before melt-kneading was changed to before fine pulverization, the volume average particle diameter of the resulting toner particles was 5.5 μm and the circularity thereof measured using FPIA (manufactured by Sysmex Corporation) was 0.94. Further, the yield was 95%. This toner is designated as Toner I.

### EXAMPLE 5

When toner particles were produced in the same manner as in Example 1 except that the binder resin used was changed to a styrene/butadiene copolymer resin synthesized through emulsion polymerization, the volume average particle diameter of the resulting toner particles was 5.3 μm and the circularity thereof was 0.95. Further, the yield was 94%. This toner is designated as Toner J.

### EXAMPLE 6

When the same procedure as in Example 3 was performed except that the addition amount of dodecyl benzene sulfonic acid added before melt-kneading was changed to 4.0 parts by weight and the addition amount of sodium dodecyl benzene sulfonate added before fine pulverization was changed to 0.5 parts by weight, fine particles having a sharp particle size distribution with an average particle diameter of 0.2 μm could be produced. When toner particles were produced in the same manner as in Example 1 using these fine particles, the volume average particle diameter of the resulting toner particles was 5.3 μm and the circularity thereof measured using FPIA (manufactured by Sysmex Corporation) was 0.95. Further, the yield was 95%. This toner is designated as Toner N.

These production methods of Examples and Comparative Examples are summarized in Table 1.

TABLE 1

| | | | | Temperature | | |
|---|---|---|---|---|---|---|
| | | | | required for | | |
| | | | Parts | uniform dispersion | Surfactant added | Parts |
| | | Additive before | by | of coloring agent | before fine | by |
| Example | Resin | kneading | weight | (° C.) | pulverization | weight |
| Example 1 | Polyester | Sodium dodecyl | 1 | 130 | Sodium dodecyl | 0.06 |
| | | benzene | | | benzene sulfonate | |
| | | sulfonate | | | | |
| Example 2 | Polyester | Amine | 2 | 140 | Sodium dodecyl | 0.3 |
| | | compound | | | benzene sulfonate | |
| Example 3 | Polyester | Dodecyl | 0.5 | 110 | Sodium dodecyl | 0.5 |
| | | benzene | | | benzene sulfonate | |
| | | sulfonic acid | | | | |
| Comparative | Polyester | non | 0 | Uniform dispersion | Sodium dodecyl | 1.5 |
| Example 1 | | | | could not be | benzene sulfonate | |
| | | | | achieved at 140° C. | | |
| Comparative | Polyester | Dodecyl | 6 | 110 | Sodium dodecyl | 0.06 |
| Example 2 | | benzene | | | benzene sulfonate | |
| | | sulfonic acid | | | | |
| Comparative | Polyester | Dodecyl | 6 | 110 | Sodium dodecyl | 0.06 |
| Example 3 | | benzene | | | benzene sulfonate | |
| | | sulfonic acid | | | | |
| Comparative | Polyester | Amine | 4.5 | 140 | Sodium dodecyl | 0.3 |
| Example 4 | | compound | | | benzene sulfonate | |
| Comparative | Polyester | non | 0 | 130 | Sodium dodecyl | 0.06 |
| Example 5 | | | | | benzene sulfonate | |
| Comparative | Polyester | Sodium dodecyl | 1 | 130 | Sodium dodecyl | 0.06 |
| Example 6 | | benzene | | | benzene sulfonate | |
| | | sulfonate | | | | |
| Example 4 | Polyester | non | 0 | 140 | Dodecyl benzene | 1.06 |
| | | | | | sulfonic acid + | |
| | | | | | Sodium dodecyl | |
| | | | | | benzene sulfonate | |
| Example 5 | Styrene/ | Sodium dodecyl | 1 | 130 | Sodium dodecyl | 0.06 |
| | butadiene | benzene | | | benzene sulfonate | |
| | copolymer | sulfonate | | | | |
| Example 6 | Polyester | Dodecyl | 4.0 | 110 | Sodium dodecyl | 0.5 |
| | | benzene | | | benzene sulfonate | |
| | | sulfonic acid | | | | |

| | | Fine | Fine | | Toner | | |
|---|---|---|---|---|---|---|---|
| | Total | pulverization | particle | | particle | | |
| | neutralization | temperature | diameter | Aggregating | diameter | | |
| Example | degree (%) | (° C.) | (μm) | agent | (μm) | Circularity | Toner |
| Example 1 | 100 | 160 | 0.82 | Hydrochloric | 5 | 0.98 | A |
| | | | | acid | | | |
| Example 2 | 100 | 160 | 0.65 | Hydrochloric | 4.8 | 0.97 | B |
| | | | | acid | | | |
| Example 3 | 100 | 140 | 0.7 | Hydrochloric | 5 | 0.98 | C |
| | | | | acid | | | |
| Comparative | 100 | 180 | 0.82 | Hydrochloric | 6.3 | 0.9 | D |
| Example 1 | | | | acid | | | |
| Comparative | 100 | 140 | 0.13 | Hydrochloric | Toner particles could not be | | |
| Example 2 | | | | acid | produced. | | |
| Comparative | 100 | 140 | 0.13 | Aluminum | 4.9 | 0.94 | E |
| Example 3 | | | | sulfate | | | |
| Comparative | 225 | 160 | 0.45 | Hydrochloric | 5.2 | 0.97 | F |
| Example 4 | | | | acid | | | |
| Comparative | 100 | 180 | 2.5 | Hydrochloric | 18.5 | 0.91 | G |
| Example 5 | | | | acid | | | |
| Comparative | 25 | 180 | 2.8 | Hydrochloric | 23.4 | 0.93 | H |
| Example 6 | | | | acid | | | |
| Example 4 | 100 | 150 | 0.9 | Hydrochloric | 5.5 | 0.94 | I |
| | | | | acid | | | |
| Example 5 | 100 | 160 | 0.82 | Hydrochloric | 8.3 | 0.95 | J |
| | | | | acid | | | |
| Example 6 | 100 | 140 | 0.2 | Hydrochloric | 5.3 | 0.95 | K |
| | | | | acid | | | |

Further, the electrophotographic toner using the thus produced toner particles was placed in a multifunction machine e-STUDIO 3510c manufactured by Toshiba Tec Corporation modified for evaluation, and transferability, fixability and image density property were evaluated. The results are shown in the following Table 2. The transferability is evaluated based on a transfer efficiency calculated from a developed amount of toner and a residual transfer amount of toner remaining on a belt after transfer; the fixability is evaluated based on a fixing temperature which is defined as a lowest temperature at which a good image without fixing failure is obtained from a solid image having a toner deposition amount of 0.9 mg/cm²; and the image density property is evaluated based on an amount of toner per unit area required for obtaining an image density(ID) of 1.5.

TABLE 2

| | | | Toner amount | |
|---|---|---|---|---|
| | | | required for | |
| | Transfer | Lowest fixing | obtaining image | |
| | efficiency | temperature | density of 1.5 | Comprehensive |
| Toner | (%) | (° C.) | (mg/cm²) | evaluation |
| A | 96 | 130 | 0.35 | ◯ |
| B | 95 | 150 | 0.32 | ◯ |
| C | 96 | 120 | 0.36 | ◯ |
| D | 91 | 150 | 0.45 | Δ |
| E | 85 | 160 | 0.42 | Δ |
| F | 90 | non | Measurement | X |
| | | | could not be | |
| | | | performed | |
| | | | because toner | |
| | | | was not fixed. | |
| G | 75 | 160 | 0.5 | X |
| H | 75 | 160 | 0.55 | X |
| I | 94 | 120 | 0.38 | ◯ |
| J | 93 | 170 | 0.37 | Δ |
| K | 90 | 130 | 0.45 | ◯ |

As in the above, it was found that when a polyester resin is melt-kneaded in the presence of a surfactant, a coloring agent can be uniformly dispersed at a lower temperature. Further, since the treatment temperature during fine pulverization can also be lowered, toner particles can be produced with lower energy. Further, an electrophotographic toner excellent in transferability, fixability, image density property and the like can be produced.

Incidentally, the method of the invention is preferred for producing colored particles with a small particle diameter, and therefore, it can be applied also to wet electrophotography in a state of a dispersion liquid and electronic paper using toner particles in addition to the application to powder.

### EXAMPLE 7

90 parts by weight of a polyester resin, 5 parts by weight of a cyan pigment, 4 parts by weight of an ester wax and 1 part by weight of a charge controlling agent were mixed. Then, 99 parts by weight of the resulting mixture, 25 parts by weight of a 4% aqueous solution of sodium dodecyl benzene sulfonate and 25 parts by weight (corresponding to an amount which achieves 100% neutralization) of a 4% aqueous solution of an amine compound were mixed, whereby a toner material mixture was prepared.

A 1 g portion was collected from the toner material mixture as a sample, and the sample was loaded onto a MX-50 moisture meter manufactured by AND Inc. Then, the water content was calculated from the weight of the sample at room temperature and the weight of the sample after water was removed by heating to 100° C. and found to be 30% by weight.

Subsequently, the toner material mixture was introduced to a twin-screw kneader having seven cylinders.

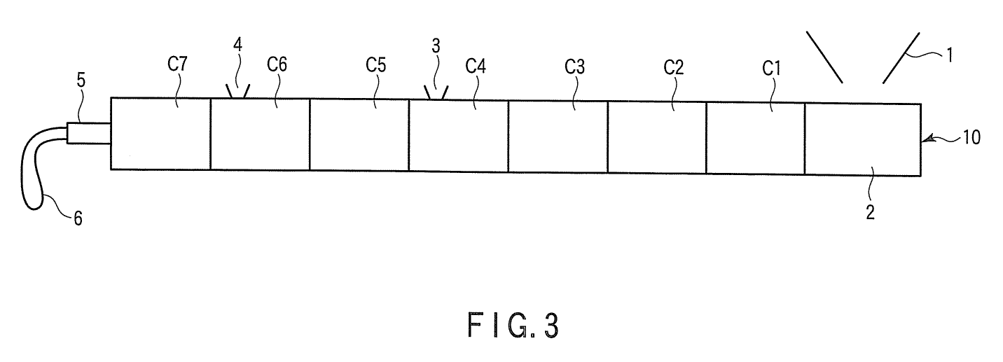

FIG. 3 shows a schematic diagram for illustrating a configuration of the twin-screw kneader.

As shown in the drawing, the twin-screw kneader 10 is provided below a hopper 1 for feeding the stored toner material mixture, and has an introduction section 2 which receives the toner material mixture to be fed, seven cylinders C1 to C7 which are connected to the introduction section 2 and are linked to one another, two screws which are not shown and are provided in any of the cylinders C1 to C7, seven heating units which are not shown and provided in the cylinders C1 to C7, respectively, and are capable of independently setting the temperatures of the cylinders C1 to C7, a first vent port 3 and a second vent port 4 which are provided in the cylinders C4 and C6, respectively, and a discharge section 5 which is provided at an end of the cylinder C7 and discharges a finally obtained kneaded material 6.

The temperatures of the cylinders C1 to C7 of the twin-screw kneader having the configuration as described above were set to 80° C., 80° C., 80° C., 120° C., 80° C., 120° C. and 80° C., respectively, and the toner material mixture was melt-kneaded.

A 1 g portion was collected from the thus obtained kneaded material as a sample, and the water content in the sample was determined in the same manner as the sample of the toner material mixture and found to be 3% by weight.

Further, a portion of the kneaded material was collected as a sample, and when the sample was melted and spread on a slide glass and observed with a light microscope, coarse particles of the pigment with a size of 1 μm or more were not observed.

By this procedure, it was found that the dispersion of the toner material mixture was good. Further, pipe clogging or the like did not occur during kneading and discharging.

The kneaded material was further pulverized to a size less than 100 μm using a bantam mill. 30 parts by weight of the thus pulverized kneaded material, 0.06 parts by weight of sodium dodecyl benzene sulfonate, 2 parts by weight (corresponding to an amount which achieves 100% neutralization) of an amine compound and 67.94 parts by weight of ion exchanged water were mixed and melted by heating to 160° C. using a high-pressure homogenizer NANO 3000 and subjected to shearing force at a treatment pressure of 150 MPa, followed by cooling, whereby a fine particle dispersion liquid was obtained. The volume average particle diameter of the thus obtained fine particles was measured using SALD-7000 (manufactured by Shimadzu Corporation) and found to be 0.82 μm. The thus obtained fine particle dispersion liquid was diluted, and an aqueous solution of hydrochloric acid was added thereto, and the temperature of the mixture was gradually raised to 70° C. to aggregate the fine particles to a desired volume average particle diameter, whereby colored particles were obtained. To maintain the volume average particle diameter of the colored particles, a dispersant was added thereto, and to control the shape of the colored particles, the temperature of the mixture was raised to 90° C., and the mixture was left as such for 3 hours. After cooling the mixture, the thus obtained colored particles were washed using a centrifuge until the electrical conductivity of washing water after washing became 50 μS/cm. Thereafter, the resulting colored particles were dried using a vacuum dryer until the water content became 0.3 wt %. After drying, 2 parts by weight of hydrophobic silica and 0.5 parts by weight of titanium oxide were adhered to the surface of the colored particles, whereby an electrophotographic toner was obtained. The volume average particle diameter of the thus obtained electrophotographic toner was measured using a coulter counter (manufactured by Beckman Coulter, Inc.) and found to be 5.0 μm, and the circularity thereof was measured using FPIA (manufactured by Sysmex Corporation) and found to be 0.98. Further, the yield was 98%. This toner is designated as Toner K.

### COMPARATIVE EXAMPLE 7

A toner material mixture was prepared in the same manner as in Example 7 by mixing 99 parts by weight of the mixture, 25 parts by weight of a 4% aqueous solution of sodium dodecyl benzene sulfonate and 25 parts by weight (corresponding to an amount which achieves 100% neutralization) of a 4% aqueous solution of an amine compound. The water content in the toner material mixture was determined and found to be 30% by weight.

The toner material mixture was melt-kneaded in the same manner as in Example 7 except that all the temperatures of the cylinders C1 to C7 of the twin-screw kneader were set to 80° C., whereby a kneaded material was obtained. A 1 g portion was collected from the thus obtained kneaded material as a sample, and the water content in the sample was determined in the same manner as in Example 7 and found to be 15% by weight.

A toner was obtained from the thus obtained kneaded material in the same manner as in Example 7.

As a result, the dispersion of the toner material mixture was not sufficient, and the particle size distribution of the obtained fine particles was broad. Further, pipe clogging occurred during kneading and discharging.

### COMPARATIVE EXAMPLE 8

A toner material mixture was prepared in the same manner as in Example 7 by mixing 99 parts by weight of the mixture, 25 parts by weight of a 4% aqueous solution of sodium dodecyl benzene sulfonate and 25 parts by weight (corresponding to an amount which achieves 100% neutralization) of a 4% aqueous solution of an amine compound. The water content in the toner material mixture was determined and found to be 30% by weight.

The toner material mixture was melt-kneaded in the same manner as in Example 7 except that all the temperatures of the cylinders C1 to C7 of the twin-screw kneader were set to 120° C., whereby a kneaded material was obtained. A 1 g portion was collected from the thus obtained kneaded material as a sample, and the water content in the sample was determined in the same manner as in Example 7 and found to be 2% by weight.

A toner was obtained from the thus obtained kneaded material in the same manner as in Example 7.

As a result, since the water content was too high, the dispersion of the toner material mixture was not sufficient. Further, kneading was poor, and the dispersion of the components of the kneaded material was not sufficient.

### EXAMPLES 8 AND 9, AND COMPARATIVE EXAMPLES 9 TO 12

90 parts by weight of a polyester resin, 5 parts by weight of a cyan pigment, 4 parts by weight of an ester wax and 1 part by weight of a charge controlling agent were mixed in the same manner as in Example 7, and then, to 99 parts by weight of the resulting mixture, an aqueous solution of different concentration of sodium dodecyl benzene sulfonate and an aqueous solution of different concentration of an amine compound were added in different amounts as shown in the following Table 3 and all the components were mixed, whereby a toner material mixture was prepared.

TABLE 3

| | | Aqueous solution | | | |
|---|---|---|---|---|---|
| | | of sodium dodecyl | | Aqueous solution of | |
| | | benzene sulfonate | | amine compound | |
| | Mixture | concen- | | concen- | |
| | (parts by | tration | parts by | tration | parts by |
| | weight) | (%) | weight | (%) | weight |
| Example 7 | 99 | 4 | 25 | 4 | 25 |
| Example 8 | 99 | 13 | 8 | 13 | 8 |
| Example 9 | 99 | 3 | 35 | 3 | 35 |
| Comparative | 99 | 4 | 25 | 4 | 25 |
| Example 7 | | | | | |
| Comparative | 99 | 4 | 25 | 4 | 25 |
| Example 8 | | | | | |
| Comparative | 99 | 26 | 4 | 26 | 4 |
| Example 9 | | | | | |
| Comparative | 99 | 1.3 | 78 | 1.3 | 78 |
| Example 10 | | | | | |
| Comparative | 99 | 17 | 6 | 17 | 6 |
| Example 11 | | | | | |
| Comparative | 99 | 2.3 | 45 | 2.3 | 45 |
| Example 12 | | | | | |

The water contents of the thus obtained respective toner material mixtures are shown in the following Table 4.

It was found that in Examples 7 to 9, the dispersion of material was favorable and the particle size distribution was sharp.

However, in Comparative Examples 9 and 11, the particle size distribution was broad.

The temperatures of the cylinders C1 to C7 of the twin-screw kneader were set as shown in the following Table 4 and the toner material mixture was melt-kneaded, whereby a kneaded material was obtained. Incidentally, the water contents of Comparative Examples 10 and 12 were 60% and 45%, respectively. Therefore, since the water content was too high, the material could not be uniformly mixed, and thus, kneading was not performed.

The water contents of the thus obtained respective kneaded materials are also shown in the following Table 4.

TABLE 4

| | | | | | | | | Water | Water |
|---|---|---|---|---|---|---|---|---|---|
| | Cylinder temperature | | | | | | | content | content |
| | | | | C4 (° C.) | | C6 (° C.) | | before | after |
| | C1 | C2 | C3 | (first vent | C5 | (second | C7 | kneading | kneading |
| | (° C.) | (° C.) | (° C.) | port) | (° C.) | vent port) | (° C.) | (%) | (%) |
| Example 7 | 80 | 80 | 80 | 120 | 80 | 120 | 80 | 30 | 3 |
| Example 8 | 80 | 80 | 80 | 120 | 80 | 120 | 80 | 10 | 1 |
| Example 9 | 80 | 80 | 80 | 120 | 80 | 120 | 80 | 40 | 4 |
| Comparative | 80 | 80 | 80 | 80 | 80 | 80 | 80 | 30 | 15 |
| Example 7 | | | | | | | | | |
| Comparative | 120 | 120 | 120 | 120 | 120 | 120 | 120 | 30 | 2 |
| Example 8 | | | | | | | | | |
| Comparative | 80 | 80 | 80 | 120 | 80 | 120 | 80 | 5 | 0.5 |
| Example 9 | | | | | | | | | |
| Comparative | 80 | 80 | 80 | 120 | 80 | 120 | 80 | 8 | 1 |
| Example 11 | | | | | | | | | |

As a result, in Examples 7 to 9, the kneaded materials did not clog the pipe, and the dispersibility of the material was also favorable. In Comparative Example 7, pipe clogging occurred, and in Comparative Example 8, kneading was poor, and therefore the dispersibility of the material was not favorable. In Comparative Examples 9 and 11, the particle size distribution was broad.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for producing a developing agent comprising:
forming a kneaded material by preparing a toner material mixture containing a binder resin and a coloring agent and melt-kneading the toner material mixture;
forming a particulate mixture by pulverizing the kneaded material;
forming a dispersion liquid of the particulate mixture by dispersing the particulate mixture in an aqueous medium; and
forming fine particles having a particle diameter smaller than that of the particulate mixture by subjecting the dispersion liquid to mechanical shearing to finely pulverize the particulate mixture, wherein
to at least either one of the toner material mixture and the dispersion liquid of the particulate mixture, at least either one surfactant of an acid having a surface-active function and a salt having a surface-active function is added in an amount of from 0.1 to 5% by weight of the total weight of the developing agent.

2. The method according to claim 1, wherein the surfactant contains at least an acid having a surface-active function.

3. The method according to claim 1, wherein
the binder resin has an acid value,
the dispersion liquid of the particulate mixture further contains a pH adjusting agent, and either one or both of the surfactant and the pH adjusting agent are added to the toner material mixture, and
an addition amount of the pH adjusting agent is an amount which achieves 50 to 200% neutralization of the acid value of the binder resin.

4. The method according to claim 1, wherein
an aqueous solution of the surfactant is added to the toner material mixture, and
a water content in the toner material mixture is from 10 to 40% by weight, and a water content in the kneaded material is from 0.1 to 5% by weight.

5. The method according to claim 3, wherein
an aqueous solution of the surfactant and an aqueous solution of the pH adjusting agent are added to the toner material mixture, and
a water content in the toner material mixture is from 10 to 40% by weight, and a water content in the kneaded material is from 0.1 to 5% by weight.

6. The method according to claim 1, wherein the melt-kneading is performed using a twin-screw kneader, the twin-screw kneader has a plurality of cylinders, a temperature (A) of a cylinder connected to a vent port for discharging excess gas is set to 100 to 130° C., and a temperature (B) of the other cylinders is set to 50 to 90° C., and the following relationship is satisfied:
A−B≦10.

7. The method according to claim 3, wherein the pH adjusting agent is an amine compound.

8. The method according to claim 1, wherein the surfactant is anionic.

9. The method according to claim 1, wherein the acid having a surface-active function is selected from the group consisting of alkyl benzene sulfonic acids, alkyl sulfonic acids, alkyl disulfonic acids, alkyl phenol sulfonic acids, alkyl naphthalene sulfonic acids, alkyl tetralin sulfonic acids, alkyl allyl sulfonic acids, petroleum sulfonic acids, alkyl benzimidazol sulfonic acids, higher alcohol ether sulfonic acids, alkyl diphenyl sulfonic acids, long-chain alkyl sulfate esters, higher alcohol sulfate esters, higher alcohol ether sulfate esters, higher fatty acid amide alkylol sulfate esters, higher fatty acid amide alkylated sulfate esters, sulfated fatty acids, sulfosuccinate esters and resin acid alcohol sulfuric acids.

10. The method according to claim 1, wherein the salt having a surface-active function is selected from the group consisting of anionic surfactants including sulfate ester salt types, sulfonate salt types and phosphate ester types; cationic surfactants including amine salt types and quaternary ammonium salt types; nonionic surfactants including polyethylene glycol types, alkyl phenol ethylene oxide adduct types and alcohol types; and amphoteric surfactants including alkyl betaine types and alkyl amine oxide types.

11. The method according to claim 1, further comprising forming aggregated particles by aggregating the fine particles.

12. The method according to claim 1, wherein the fine particles have a volume average particle diameter of from 0.05 to 10 μm.

13. The method according to claim 11, wherein the aggregated particles have a volume average particle diameter of from 1 to 15 μm.

14. The method according to claim 11, wherein the aggregated particles have a circularity of from 0.8 to 1.0.

15. The method according to claim 1, wherein the binder resin is a polyester resin having an acid value of 1 or more.

16. The method according to claim 1, wherein the mechanical shearing is performed at a temperature not lower than the glass transition temperature of the binder resin.

17. The method according to claim 11, wherein in the formation of the aggregated particles, a plurality of the fine particles are aggregated using at least one process selected from the group consisting of pH adjustment, addition of a surfactant, addition of a water-soluble metal oxide, addition of an organic solvent and temperature adjustment.
